(19) United States
(12) Patent Application Publication
(10) Pub. No.: US 2022/0271963 A1
(43) Pub. Date: Aug. 25, 2022

(54) SYSTEM AND METHOD FOR CUSTOMIZED REMINDERS

(71) Applicant: Avaya Management L.P., Durham, NC (US)

(72) Inventors: Shamik Shah, Pune (IN); Asmita Gokhale, Pune (IN); Valentine C. Matula, Granville, OH (US)

(21) Appl. No.: 17/185,481

(22) Filed: Feb. 25, 2021

(51) Int. Cl. H04L 12/18; G06N 3/04; G06Q 10/02

(52) U.S. Cl. CPC H04L 12/1818; G06N 3/04; G06Q 10/02

(57) ABSTRACT

Fixed-time meeting notifications are almost always wrong in terms of the time required for a user to be presented with the notification, attend to all preliminary matters necessary, and join the meeting. Either there is too much time, in which case the advance notification is more of a distraction, or too little. By dynamically determining delay factors associated with a meeting, such as time to locate to the meeting room or appropriate location to join a remote meeting, launch applications, and tending to personal needs, a meeting notification may be provided just-in-time to allow the user to proceed with all the preliminary matters, without rushing or being late, in order to join the meeting at the user's preferred time, which may or may not coincide with the start of the meeting.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for automatic communications and particularly to system-determined notifications of future events.

### BACKGROUND

Online meetings, conferences, classes, and webinars continue to gain popularity, especially with a trend towards working from home. More and more sectors and industries, that previously required only onsite attendance are adapting to remote conferences. As a result, more people frequently use online meetings and conferences as a mode to collaborate, and the number of meetings attended by any person often increases as he or she rises in the corporate hierarchy.

While remote conferences and other remote meetings are becoming more commonplace, on-site meetings are often still required in situations where a user's physical presence is necessary. Meetings may have a reminder, such as fifteen-minute prompt before all scheduled meetings. While fixed-time reminders may be sufficient in some circumstances, this may not be universally true. As a result, reminders may be triggered either too early, and result in an unnecessary distraction, or too late, and result in the user being late, unprepared, or miss the meeting entirely.

### SUMMARY

Calendar systems are often relied upon to provide meeting reminders at a specified time before the meeting. However, these reminders are fixed—they do not dynamically take into account the attendee's physical situation, past habits, time to connect to a network, launch applications, or other considerations. Similarly, fix-time reminders do not consider the relative importance of a meeting. While some meetings may have a “must not be late” importance, others may have a “I'll get there when I get there,” priority. Fixed-time reminders may come well in advance, and cause the user to be unnecessarily distracted from other tasks, such as when the upcoming meeting requires little to no preparation or travel time. Similarly, a fixed-time reminder of a meeting that requires travel, such as when the user is currently located in another building of a multi-building campus, time to connect to a network, launch an application, and/or other preparations may fall short and cause the user to be rushed, late, or unprepared.

This may be particularly evident when a user has successfully relied upon a particular fixed-time reminder in the past. For example, a user may be used to working on a task and be presented with a pop-up or other reminder that a staff meeting is about to start in fifteen minutes. In past occurrences, this notification may have proven sufficient and the user is able to attend the meeting, and complete any other pre-meeting tasks, in time for the meeting to start. Such meetings may be routine and allow the user to rightfully be complacent as the reminder has always been sufficient in the past. However, the user may have been called to a different location, either by an earlier scheduled meeting or an impromptu event. As a result, the user now needs an additional ten minutes to travel to the meeting location or find an alternative location to conduct a remote meeting. A prior art, fixed-time reminder, may result in the user missing at least a portion of the meeting.

These and other needs are addressed by the various embodiments and configurations of the present invention. The present invention can provide a number of advantages depending on the particular configuration. These and other advantages will be apparent from the disclosure of the invention(s) contained herein.

In one embodiment, systems and methods are provided to automatically determine when a meeting reminder should be provided, a re-reminder triggered such as based on a user's action or lack of action, and/or the type(s) of reminders that should be provided (e.g., tones, louder tones, different tones, spoken warnings, SMS messages, etc.). Additionally or alternatively, upon determining the user will be late, or late beyond a threshold amount of time, automatic notification may be provided to the host and/or participants, which may include a specific amount of time the user will be late.

For example, a meeting with a modest number of participants, such as ten, each receiving the prior-art fixed time reminder (e.g., fifteen minutes in advance of the meeting). For many participants, joining a meeting right at the time of the meeting (e.g., within less than one minute of the scheduled start time), discounting the other factors which play a role or even a significant role, in being able to join and/or participant in the meeting. For example, remote meetings may require logging in and establishing an internet connection, VPN setup, mobile network connectivity, launching a particular conferencing application, etc. As a result, meetings rarely start at the designated start late and participants often miss the initial part of the meetings. The problem increases exponentially as the number of participants increase. The problem also has a cascading effect for the people having back-to-back meetings or those running on a tight schedule. The static meeting reminders are easy to implement—but they fail to consider factors that may impact an attendee's ability to attend the meeting on time. Such factors may be routine, such as when a participant needs to relocate to a conference room from their desk. However, default reminders often fail to consider the time that is actually required. For example, the conference room may be only a few steps away, on a different floor, in a different building, or at a different site altogether. As a result, a default fifteen-minute reminder requires manual modification, assuming the participant remembers to make such a modification, or risk being late or distracted by an unnecessarily early notification. Other factors may be a matter of preference. For example, time may be required to attend to one's appearance before a video call with a customer or senior management, whereas the attendee may not require such additional time for meetings with other participants. A current meeting may be of high priority and being late for the next meeting deemed to be acceptable, for one participant, but another participant may have different priorities.

In one embodiment, an artificial intelligence (AI), neural network, and/or other machine learning (ML) is provided to enables a system to dynamically determines the timing and type of reminders necessary for a person to attend a meeting at the desired time. Over time the system learns which factors are more important and less important to further refine the timing and provide an accurate notification to allow the user, upon receiving the notification, to attend to any pre-meeting activities (e.g., relocate, sign-on, etc.) to be completed at a time corresponding to the desired start time of the meeting.

The specific factors utilized may be machine-discovered/determined and/or seeded, such as by known factors. The factors considered include, but are not limited to, the following:

Network speed and alternatives: Based on the speed of the network utilized for connecting to a remote meeting, the reminder time is adjusted. For example, a slow or otherwise problematic network connection may require more time to join a particular remote meeting. Additionally or alternatively, if an alternative connection is known, then the meeting reminder may have a different, or no, time adjustment but comprise a hint, option, instruction, link, etc., to enable the user to switch to the more suitable network—and with the reminder being provided at a time to account for the switching of networks. As a further option, recurrences of the same or similar meetings (e.g., same connection type, same physical location of the suer, and same networking resources, etc.) comprises an allocated time appropriate to join the meeting on the selected network.

Location: If the user is travelling, moving, at a particular location, or at an undetermined location known to not be the meeting location (e.g., location of a meeting, available computer, etc.), a location indicator of a mobile device may be utilized to determine the location of the user. Additionally or alternatively, locations may be accessed in data storage or online resource to identify suitable places in which to conduct the meeting. For example, if a remote meeting requires the user to speak, being in a quiet location may be the designated best location. In another example, the meeting is known to require a high bandwidth connection, such as when the meeting comprises a high degree of visual information (e.g., high resolution images, video, etc.) that are key to conveying the content of the meeting, then a location having sufficient bandwidth may be determined as the best location. If more than one location is identified, further selection may be made as the closest of the suitable locations and the meeting notification time adjusted accordingly for travel time, connecting, etc. Optionally, a user may be provided with options or hints of the other locations.

Suitable Environment: With the help of microphone on user's mobile device or laptop or other device, the amount of ambient noise in the user's current surroundings may be determined. Based on the history of places from where the user takes the meetings, the nearest suitable location, and the time required to reach get to the location, is selected and a hint/option may be provided to the user at the appropriate time adjusted accordingly for travel to the location.

Another version of this is that the AI/ML learns how long it takes for the person to make the environment quieter at a designated meeting location. This may comprise time spent to move children out of a home office, turn off music, turn off air conditioners, etc., Additionally, or alternatively, the AI/ML may access a microphone at the location and determine the type of noise (e.g., adults speaking, children speaking, passersby in a hallway, airport noise, vacuum cleaners, street noise, etc.) as input for how long to give person to stop the noise or move to a quieter location.

Personal Needs: With the help of the camera on the user's device, and based on the subject, context and importance of the meeting, the user is scanned for his/her appearance. The reminder time is adjusted based on whether the user's current appearance is suitable for the said meeting, considering the past history of time taken for a makeover of the appearance. It should also be possible to provide such a hint/option to the user.

Schedule: The current schedule of the user is also taken as a delay factor. If the user has been attending back-to-back meetings, calls, and is now heading towards a high-priority/high-importance meeting, then the reminder is adjusted accordingly such that the user is provided time for attend to personal tasks before the next meeting. For example, if a user has an upcoming meeting, but has been previously engaged in a prior meeting, adding sufficient time to eat, take a break, or otherwise refresh may be incorporated into the timing of the reminder. This may be adjusted based on the meeting and a determined importance, such that the user is refreshed and on time at the start of an important meeting. The reverse is also possible—the current session is ranked important, while the following session might have much lower priority. In this case, the AI may determine that less frequent reminders, quieter reminders, or no reminders at all have been preferred in the past by the attendee, and thus shape the response to the current situation and not distract the user with unwanted low-priority reminders.

Resources required: Based on attributes of the meeting (e.g., subject, references, attachments, etc.) the resources required for the meeting are identified. For example, if the meeting invite contains an attachment which requires a few minutes to be opened (based on a past history and/or hardware of the current system), then the meeting reminder is adjusted accordingly, and the user is prompted of the same. Resources are also identified based on past history of the resources used in a recurring meeting, or based on the context and subject of the meeting. In another embodiment, a listing of the resources required is identified, which may be provided to the user. The time to prepare for the meeting adjusted to include the current availability of those resources/applications. For example, the user may want to show a PowerPoint presentation, a reference weblink, a video, and an Excel spreadsheet. If only one or some of those resources are currently opened, then the meeting time is adjusted based on time required to get on to the remaining resources.

The examples herein refer to a user which may be participant and/or a presenter of a virtual meeting, an in-person meeting, or a combination thereof. If a user is determined to be unable to make the meeting on time, the system will provide the user, participants, and/or host of a meeting with a notification of the amount of time the user will be late. As a further option, messages may be provided to a meeting host and/or other participants, such as:

1. I need additional time to join/prepare for the meeting.

2. I'll be there shortly. Please start without me.

3. I am busy with a customer.

4. I'm getting the reminders, but . . . [user provided reason].

The message may also be provided as an input to the AI algorithm/engine for enhancing its future predictions.

A cloud based smart meeting reminder can be integrated with all the devices used by the user and at all places. It will also be useful for in-office meetings for the list of factors considered.

In another embodiment, the AI/ML system learns from the user and/or other users. For example, if different users are attempting to use a location or networking resource but finding it problematic (e.g., poor connectivity, noisy, etc.) then a current user may be provided with a notification that considers the additional time to connect, time to move to a different location, etc. As a further option, when the user is relocating to the meeting or to a location to remotely connect to a meeting, the time required may be determined and factored into the notification timing. For example, an elevator being out of service, traffic delay, weather-based delays, etc., may determine, at least in part, when to trigger the meeting notification.

In one embodiment, a system is disclosed, comprising: a network interface to a network; a data storage; and a processor having machine-readable instructions maintained in a non-transitory memory that when read by the processor cause the processor to perform: access a meeting on a calendar of a user, the meeting maintained as a data record in the data storage; access a desired start time of the meeting for the user; determine a number of delay factors, corresponding to a number of attributes associated with the meeting that will be encountered by the user between a notification message being presented by a user device and the user joining the meeting; determine an advance notification time for the meeting comprising the number of delay factors before the desired start time; and cause the user device to present the notification at the advance notification time.

In another embodiment, a method is disclosed, comprising: accessing a meeting on a calendar of a user, the meeting maintained as a data record in a data storage; accessing a desired start time of the meeting for the user; determining a number of delay factors, corresponding to a number of attributes associated with the meeting that will be encountered by the user between a notification message being presented by a user device and the user joining the meeting; determining an advance notification time for the meeting comprising the number of delay factors before the desired start time; and causing the user device to present the advance notification at the notification time.

In another embodiment, a system is disclosed, comprising: means to access a meeting on a calendar of a user, the meeting maintained as a data record in a data storage; means to access a desired start time of the meeting for the user; means to determine a number of delay factors, corresponding to a number of attributes associated with the meeting that will be encountered by the user between a notification message being presented by a user device and the user joining the meeting; means to determine an advance notification time for the meeting comprising the number of delay factors before the desired start time; and means to cause the user device to present the advance notification at the notification time.

A system on a chip (SoC) including any one or more of the above embodiments or aspects of the embodiments described herein.

One or more means for performing any one or more of the above embodiments or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects of the embodiments, wherein the data storage comprises a non-transitory storage device comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a first data structure in accordance with embodiments of the present disclosure;

FIG. 3 depicts a second data structure in accordance with embodiments of the present disclosure;

FIG. 4 depicts a third data structure in accordance with embodiments of the present disclosure;

FIG. 5 depicts a fifth data structure in accordance with embodiments of the present disclosure;

FIG. 6 depicts a sixth data structure in accordance with embodiments of the present disclosure;

FIG. 7 depicts a seventh data structure in accordance with embodiments of the present disclosure;

FIG. 8 depicts a first process in accordance with embodiments of the present disclosure;

FIG. 9 depicts a second process in accordance with embodiments of the present disclosure;

FIG. 10 depicts a third process in accordance with embodiments of the present disclosure; and

FIG. 11 depicts a second system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

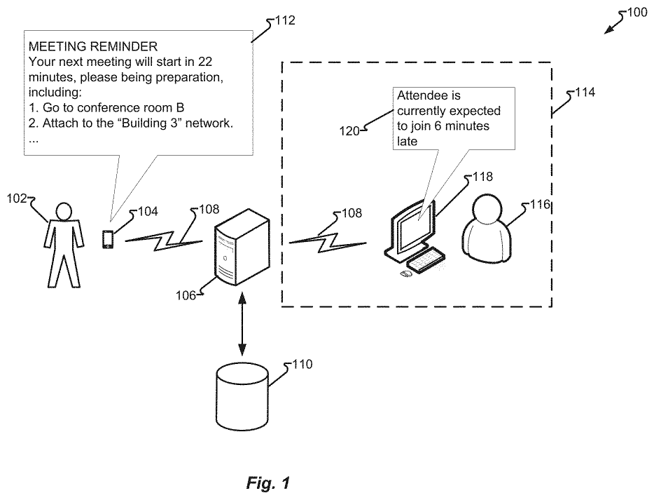

FIG. 1 depicts system 100 in accordance with embodiments of the present disclosure. In one embodiment, user 102 has associated therewith user device 104. A meeting maintained as a record in data storage 110 is accessed by at least one processor of server 106 and communicated, via data network 108 to user device 104, such as to provide advance notification 112 to notify user 102 of an upcoming meeting.

Optional system components 114 comprise one or more nodes, such as device 118 utilized by user 116. User 116 may be a host and/or participant of the upcoming meeting for which advance notification 112 relates. User 116, via device 118, may be provided with notification 120 comprise indica (e.g., name, department, title, role, etc.) of user 102 and, as determined at the time notification 120 was generated, an estimated time that user 102 will join the meeting.

It should be appreciated that the topology illustrated in system 100 may be modified without departing from the scope of the embodiments herein. For example, as illustrated, user device 104, server 106, and data storage 110 are discrete components interconnected for communication of data therebetween. However, one or more components may be combined including, user device 104 comprising server 106 and data storage 110, wherein network 108 comprises internal data bus(es) (not shown). Network 108 may comprise any known data communication medium and associated hardware including, but not limited to, one or more of the internet, Wi-Fi, Bluetooth, etc.

In one embodiment, data storage 110 comprises at least one database further comprising records for meetings to be attended by user 102. The meetings are variously embodied and may comprise one or more of in-person or remote meetings, which may be in a traditional meeting format (e.g., some or all participants discussing particular topics), or other format, such as a class, seminar, lecture, presentation, etc., for which user 102 may be a passive participant (e.g., only receiving the meeting content), active participant (e.g., receiving and providing, at least in part, meeting content), a host (e.g., managing or moderator the meeting), or a combination thereof for throughout the meeting or having a changing role during the meeting. The meeting has a scheduled start time that, with respect to the embodiments herein, is fixed and user 102 will either join, in-person or online, on-time, late, or early relative the schedule start time for the meeting. While what is considered early, late, and on-time may vary based on the host or other participants, as the terms are used herein, early refers to joining a meeting by being physically present when attending in-person, or being connected or being ready to join upon a host/moderator's initiation to start the meeting when attending a meeting online, before the meeting starts with sufficient time to attend to all pre-meeting tasks and at least one additional task. In one embodiment, joining two or more minutes before the scheduled start time is early, but in other embodiments, early may require attending five minutes or more early. Being on-time, as used herein comprises attending at a time between the scheduled start time and within two-minutes early. Being late, as used herein, refers to being unable to join the meeting until after the scheduled start time has passed.

In another embodiment, advance notification 112 is activated at a time that is determined to allow user 102 to attend to any preceding tasks in order to join the upcoming meeting at the desired start time. Accordingly, a desired start time may be different from the meeting start time. For example, user 102 may be attending a high-priority meeting before a low-priority meeting, where it is preferred to not leave the meeting early even if it causes user 102 to be late for the second meeting by some amount. Therefore, a desired start time may be after the meeting's scheduled start time. Conversely, user 102 may have a low-priority meeting or other event followed by a high-priority meeting for which may justify user 102 leaving the low-priority meeting or taking other measures to be early, therefore the desired start time may be before the scheduled start time. However, absent a previously determined desire to be early or late, the desired start time will be the meetings start time. This may have some degree of acceptable variation, such as one or two minutes early or late.

Knowing the prerequisite tasks for a meeting may be determined by server 106, such as to determine a time required for user 102 to move to the designated or acceptable location to attend the meeting, time required to gather and/or launch resources (e.g., computer applications, prepare presentation application, etc.), attend to personal needs, connect to a network, and/or other tasks that need to be performed prior to a meeting. Accordingly, server 106 may comprise one or more processors executing machine learning, neural network, and/or other artificial intelligence in order to determine meeting attributes and any delay factor associated with the attributes. In yet another embodiment, delay factors may be determined through other resources. For example, user 102 is about to attend a meeting online that will be discussing medical imaging or other bandwidth-intensive subject matter. A particular meeting room is nearby and will be available, however, a prior meeting with the same or different attendees had experienced networking issues. Accordingly, server 106 may determine an alternative location is required, namely an available meeting room that has sufficient bandwidth. Time for user 102 to move to alternative location is then determined and the timing for the delivery of advance notification 112 recalculated.

In one embodiment, events may be extracted from the meeting invite itself, such as a location requirement, software applications that will be used, networking requirements (e.g., low bandwidth audio and still images, high-resolution video, VPN, etc.). In another embodiment, the user's prior schedule maintained in data storage 110 may be utilized, such as to determine whether a break is needed after a prior meeting. In another embodiment, past occurrences of the same recurring meeting may be utilized. For example, advance notification 112 was sent twenty minutes before the meeting last week and user 102 connected five minutes late, therefore, for the next iteration of the meeting advance notification 112 will be sent twenty-five minutes before the meeting. User 102 may also provide preferences, such as may be maintained in data storage 110, such as, for all customer video calls, allow ten minutes to check appearance, any meeting in ‘building 6’ between 10:00 and 2:00, allow an extra ten minutes (in order to purchase a sandwich at the coffee shop), when having a live call (audio or audio-video) at home, remind me an extra fifteen minutes early (to allow the children to move to a different room), the desired start time for the monthly department meeting is twenty minutes after the scheduled start time, etc. Any upcoming meeting matching then utilizes the delay factor identified to provide sufficient timing of advance notification 112 to be received and allow user 102 to attend to the prerequisite tasks.

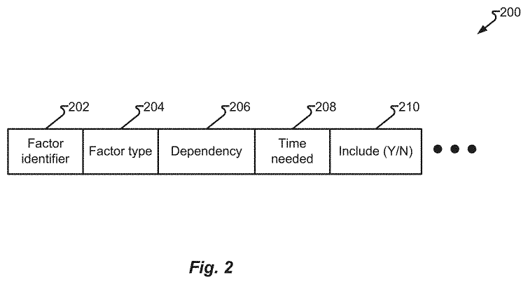

FIG. 2 depicts data structure 200 in accordance with embodiments of the present disclosure. In one embodiment, data structure 200 defines a database record for a database maintained in data storage 110. Data structure 200 comprises a number of fields utilized by a processor of server 106 to determine delay factors, the sum of the delay factors forming an advance time as the time before a meeting in which server 106 will cause advance notification 112 to be triggered on user device 104. Data structure 200 may comprise field 202 identifying, such as via index, machine-readable name, human-readable name, and/or other indicia.

Field 204 identifies a delay factor type which may be further utilized as a categorization. For example, field 204 may identify networking requirements for a particular meeting (e.g., secure, public, high capacity, etc.), and associated field 208 identifies the time required, such as additional time to load a VPN application, attach to a network, obtain the current network credentials, etc. Field 206 may identify any dependencies. For example, a VPN application may reference a network connection record so that the delay factors consider that the VPN application cannot be launched until attachment to the network is successful. Dependency field 206 may be utilized to determine any applications or other tasks that can be performed in parallel. For example, turning off a noisy air conditioner may be a task associated with an online meeting, but conducted in parallel with the launching the conferencing application utilized to conduct the online meeting. Field 210 may be utilized to determine if a particular delay factor record does or does not apply to a particular meeting. For example, a number of records may be created for all known delay factors. Factor type may indicate if a meeting is in-person, online audio-video, online audio only, etc., Therefore, meetings that are in-person may have all delay factors for records where field 204 has a factor type associated with in-person set to “no” (or equivalent) in field 210. Conversely, records having field 204 value associated with online meetings (e.g., networking, required applications, etc.) set to “yes” (or equivalent).

As a result, server 106 may iterate through a database of records having data structure 200 and determine which records apply and sum the values in field 208, less any overlap indicated by field 206.

While iterating through potential delay factors and determining which ones apply and which ones do not, and combining the delay factors of those that apply, in another embodiment, attributes of the meeting are determined and a delay factor determined therefrom. For example, the time user 102 has joined an online meeting may be compared to the scheduled start time for the meeting and deltas (i.e., differences) determined for other meetings. For example, the location utilized for one meeting may utilized an overtaxed wireless access point and result in a delay in joining, whereas a different online meeting may be conducted at a different location and joined at the desired time. Records of the meeting may be compared and differences (e.g., location, specific access point utilized, etc.) determined. As a result, a subsequent online meeting may then determine the location and/or specific access point and apply a delay factor accordingly. With additional data, such as conducting other online meetings from different locations, but serviced from a common wireless access point, the physical location may be identified as less relevant, as meetings may have similar connection performance from each location, but the access point utilized is more relevant. As a result, a time required to conduct an online meeting may have a delay factor determined to a lesser degree by location and a greater degree by the networking equipment utilized.

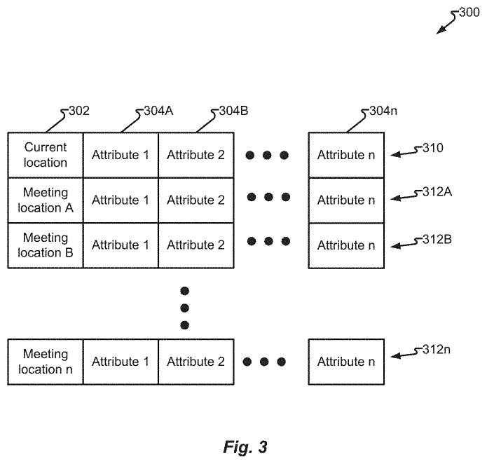

FIG. 3 depicts data structure 300 in accordance with embodiments of the present disclosure. In one embodiment, data structure 300 may define records maintained in a database of data storage 110. In one embodiment, data structure 300 comprises records 310 and 312A-n, related to location. More specifically, field 302 identifies a location. The value of field 302 may be utilized as a machine-readable and/or human-readable identifier for a location. Field 302 may have one or more values that are a conference room name, building name, and/or other feature that may be matched to a location on a meeting record. Fields 304A-n maintains attributes for known or discovered features associated with the corresponding location in field 302. For example, attributes in fields 304A-n may include alternative position descriptor, such as a latitude-longitude, building name, network, etc. Therefore, values for at least one of field 304A-n may include a position on Earth (e.g., latitude-longitude), position within a network (e.g., cell tower four, wireless access point ‘West Conference Room’, ethernet port ‘3-443’, etc.), room, building, floor, or other location that is known to system 100. As a further option, field 302 may identify a field as being unknown or invalid and, as a result, a default action taken, such as to exclude location from consideration of any delay factor.

Data structure 300 may have a number of records 312A-n for each identified location maintained in field 302. Additionally or alternatively, data structure 300 may have a dedicated record 310 for a specific user, such as user 102, which may be updated periodically or in response to a query received by server 106.

In another embodiment, server 106 determines a delay factor associated with a particular location, maintained in an instance of record 312 and/or record 310 for data storage 110. For example, if an upcoming meeting requires data storage 110 to be physically present in a location matching an entry in field 302 for a particular record 312, then a location accessed from one or more fields 304A-n. A difference is then determined based on the difference and the time required added to the notification time. In another embodiment, the location identified in field 302 may have an attribute associated with other delay factors (e.g., additional time to attach to an overtaxed network, time to clean for video calls, time to silence noisy equipment, etc.). Attributes in fields 304A-n may include additional time needed for meetings at a particular location for other reasons, such a personal preference.

When determining a time from a current location (field 302 of record 310) to a meeting location, alternatives may be suggested based on attributes. For example, field 304A may maintain an ambient noise level and, if the meeting requires data storage 110 to speak, select a location having the lowest ambient noise level and add (or subtract) any time necessary to allow data storage 110 to move to the quieter location. Additionally or alternatively, server 106 may access one or more fields 304A-n that maintain, or link to, dynamic information. For example, if location attributes in field 302 differ by a number of floors in a building, and another attribute has, or links to, information that only two of the six elevators are operational, additional time is added to the notification associated with waiting for an available elevator car.

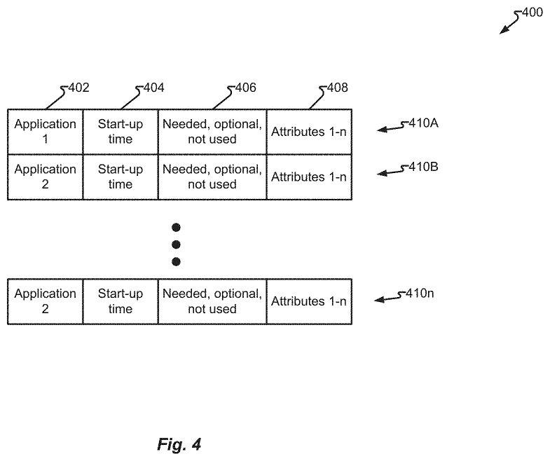

FIG. 4 depicts data structure 400 in accordance with embodiments of the present disclosure. In one embodiment, data structure 400 may define records maintained in a database of data storage 110. In one embodiment, a meeting may require one or more applications to be running on user device 104 utilized to conduct an online meeting or utilized during an in-person meeting. This may include connectivity applications, security applications, conferencing applications, and one or more document presentation applications. Applications may require a non-trivial amount of time to load, authenticate, mount any external storage volumes, connect to other resources, and/or other tasks necessary to be operational for the meeting. Accordingly, data structure 400 maintains information on applications.

In one embodiment, data structure 400 comprises a number of records 410A-n for each of a corresponding number of applications that will, or may, be utilized by user device 104 during a meeting. Field 402 maintains a name and/or other identifier of an application, field 404 maintains a startup time which may also comprise time to authenticate user 102, authenticate user device 104 to or by another service, and/or other operations. Field 406 maintains a requirement field, such as to indicate if a particular application must be operational (e.g., a conferencing application utilized during an online meeting), is optional (e.g., user 102 may want to access a spreadsheet and need a spreadsheet application), or not used (e.g., applications installed and/or available but not used for meetings). The value of field 404 may be added as a delay factor, if the associated application is required, and not added or only a portion added, if the application is optional, and not added if the application is not used. Field 408 may comprise one or more values of attributes for each application, such as prerequisite applications or if the application could be launched in parallel with other applications.

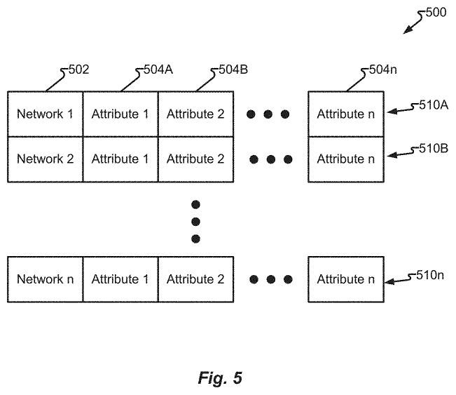

FIG. 5 depicts data structure 500 in accordance with embodiments of the present disclosure. In one embodiment, data structure 500 may define records maintained in a database of data storage 110. In one embodiment, a meeting may require network connectivity. Connectivity may be necessary for the meeting itself (e.g., online meetings) or utilized as a portion of the meeting (e.g., access networked resources during the meeting). User 102 may be able to access one or more networks or network portions (e.g., ports, access points, etc.) 502 having attributes identified by field(s) 504 for a particular record 510. Each record 510 may comprise one or more fields 504A-n to maintain attributes for the network (e.g., location, time to connect, reliability, bandwidth, times of high/low use, additional authentication tasks, etc.). The time required to connect and/or reconnect, may then be added as an overall delay, or advance notification to send or otherwise trigger advance notification 112 when the network is selected. In another embodiment, if the network is not yet selected, such as when a number of networks/network portions are available, server 106 may select a network having attributes in field 504 that match another attribute of the meeting (e.g., high bandwidth for a meeting that comprises video, etc.).

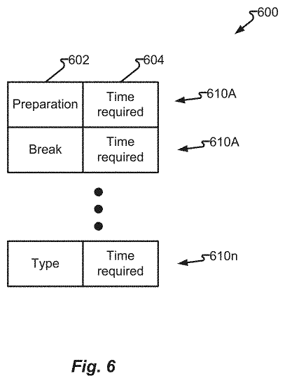

FIG. 6 depicts data structure 600 in accordance with embodiments of the present disclosure. In one embodiment, data structure 600 may define records maintained in a database of data storage 110. In one embodiment, a meeting or number of meetings may inflict a personal toll on user 102. For example, several long back-to-back meetings may necessitate user 102 taking a break, getting lunch, refreshing appearance, and/or other tasks before a next meeting. In another example, a meeting that requires relocating to an area known to have desirable food may warrant additional time to purchase lunch. Accordingly, data structure 600 may comprise a number of records 610A-n having field 602 maintaining a type of break and associated value in field 604 maintaining a value. The time required maintained in field 604 is added for records 610A-n that are deemed to apply.

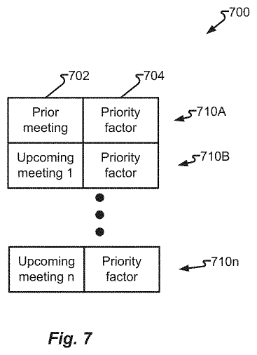

FIG. 7 depicts data structure 700 in accordance with embodiments of the present disclosure. In one embodiment, data structure 700 may define records maintained in a database of data storage 110. Not all meetings are the same. User 102 may have high and low priority meetings. A high priority meeting may require an additional delay factor so that the desired start time is earlier than the meeting's scheduled start time. A low priority meeting may be one that is known to always start late or otherwise have an acceptable consequence to being late. Accordingly, data structure 700 may maintain records 710A-n for a number of meetings past (e.g., record 710A) and/or upcoming meetings (e.g., records 710B-n). Each meeting may have an associated priority factor maintained in field 704 for each meeting maintained in field 702.

In one embodiment, the priority factor maintained in field 704 is a time value. For example, “+15 minutes” may be utilized to add fifteen minutes to the time before a particular advance notification 112 is triggered, when the meeting has a high importance. “−5 minutes may be added, or in this case subtracted, to reduce the amount of advance notice, which may be acceptable for low priority meetings. In other embodiments, the value of field 704 may be an index (e.g., high, normal, low) or other reference to a data field or structure having an associated time value (e.g., high=“+15”, normal=“+0”, low=“−5”, etc.).

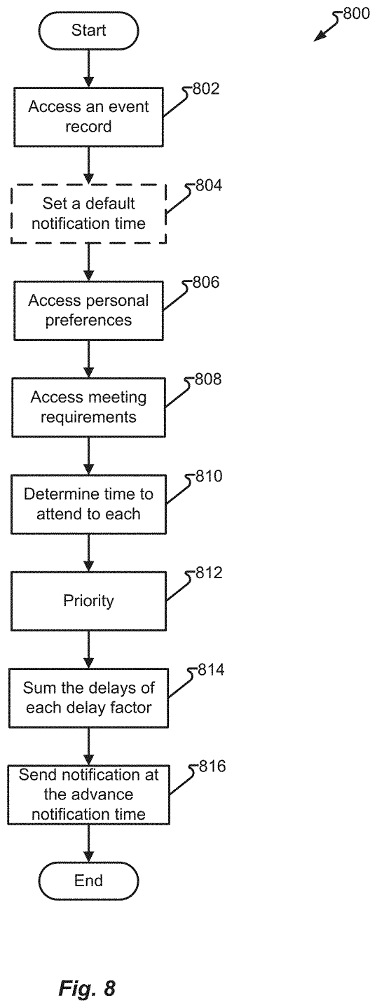

FIG. 8 depicts process 800 in accordance with embodiments of the present disclosure. Process 800 may be embodied as machine-readable instructions maintained in a non-transitory memory that, when read by a processor such as a processor of user device 104 or server 106, cause the processor to execute the steps of process 800.

In one embodiment, process 800 beings and accesses an event record in step 802. The event record may be a calendar entry, such as maintained in a calendaring database maintained in data storage 110. The event being for a meeting occurring in the future with at least one other party in-person or online. Optionally, step 804 may set a default notification trigger, such as to trigger the notification presented by user device 104 to occur at a fixed time (e.g., fifteen minutes) before the meeting. The default notification trigger then being overridden or modified as process 800 continues.

Step 806 accesses personal preferences, which may be maintained as settings or preferences in a calendaring application executing on user device 104, server 106, and/or maintained in data storage 110. The personal preferences may include rules or settings regarding meetings in general or categories of meetings. For example, to maintain the amount of time to allow for personal needs after a prior meeting or before another meeting, attend to their appearance, or how quickly they walk a given distance.

Step 808 accesses meeting requirements. This may entail parsing a meeting's agenda for content to be discussed and any associated applications. For example, “Discuss Q3 sales projections” may match the title of a document with an “xls” (Microsoft Excel spreadsheet) extension. As a result, the meeting may be determined to require Excel to be running on the user's device (e.g., user device 104). In another embodiment, a recurring meeting may have had several prior instances and during those instances a presentation and word processing application were utilized. Therefore, in an upcoming instance, the presentation and word processing applications may be determined to be necessary. In other embodiments, fuzzy logic, AI, ML, or other machine-based learning may be utilized to determine meeting requirements. For example, meetings involving certain people, departments, titles, or subject lines may not be an exact match to any prior meetings, but have some degree of overlap. For example, a prior meeting the Accounting department utilized the spreadsheet application, but not when the vice president of sales was on the meeting. Accordingly, a probability may be determined and, if the probability is greater than a previously defined threshold, the associated application is determined to be needed.

Step 808 may also access other requirements, such as the need to speak during an online meeting, which is associated with a requirement for a quiet environment, the need to be in one specific location to conduct the meeting, one of a finite set of locations, or not in one or more excluded locations. Networking requirements may also be identified and location selected in conjunction with networking and/or other physical attribute requirement and matching location(s). Additionally or alternatively, personal needs or other requirements may be identified as a consequence of an adjacent prior meeting or as a prerequisite to a particular upcoming meeting.

Step 810 then determines the time for each delay factor identified in step 808. Step 812 determines a priority for the meeting and whether additional time should be added, such as for high-priority meetings, subtracted, for low-priority meetings, or remain unchanged. The summation of the delay factors is then determined in step 814 as an advance notification time before the meeting, comprising the meeting time minus the time determined as the sum of the delays associated with each delay factor, a notification is then presented on user device 104 in step 816.

In another embodiment, the notifications may comprise a number of notifications based on time and/or priority. For example, a high-priority meeting may have an additional notification presented, such as at a time associated with high-priority meetings, and another notification triggered upon the normal time, that is, the summation of delay factors before the meeting. Additionally or alternatively, the type of alert may be modified based on time and/or priority. For example, a passive reminder may be presented for normal-priority meetings that disappears if ignored when presented before the normal notification trigger. Then, at the normal notification trigger the notification is emphasized (e.g., requires acknowledgement, louder, comprises a spoken message, etc.). Low-priority meetings may have low-priority notifications that disappear even if not acknowledged, or only require acknowledgement after the normal notification time has passed.

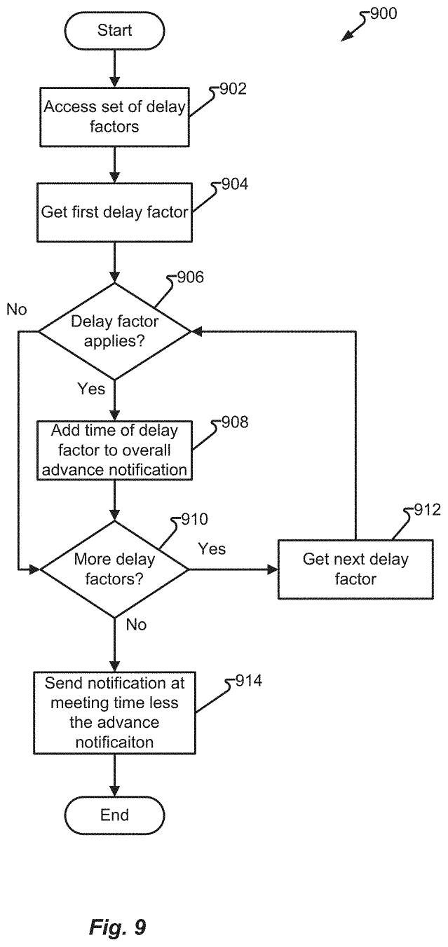

FIG. 9 depicts process 900 in accordance with embodiments of the present disclosure. Process 900 may be embodied as machine-readable instructions maintained in a non-transitory memory that, when read by a processor such as a processor of user device 104 or server 106, cause the processor to execute the steps of process 900. In some embodiments, a meeting is accessed and delay factors determined therefrom, in another embodiment, a set of known delay factors is accessed with each delay factor compared to a meeting to determine applicability. Accordingly, and in one embodiment, process 900 begins and step 902 accesses a set of delay factors, such as may be maintained in records of a database maintained in data storage 110. Delay factors may comprise time to locate to a desired or required meeting location, time to connect to a network, time to launch required software applications and tend to any configuration or document loading, time to attend to personal needs, padding (positively or negatively) the notification time based on priority, etc.

Next, step 904 accesses a first delay factor and test 906 evaluates the priority factor against the meeting to determine if the priority factor applies. If test 906 is determined in the negative, processing continues to test 910. If test 906 is determined in the affirmative, processing continues to step 908 wherein the delay associated with the delay factor is added to an overall advance notification. Test 910 determines if there are more delay factors and, if determined in the affirmative, processing continues to step 912 which obtains the next delay factor and loops back to test 906. If test 910 is determined in the negative, processing continues to step 914 and, at the appropriate time, that is, the advance time before the meeting, the notification message is sent or otherwise cause to be presented on user device 104.

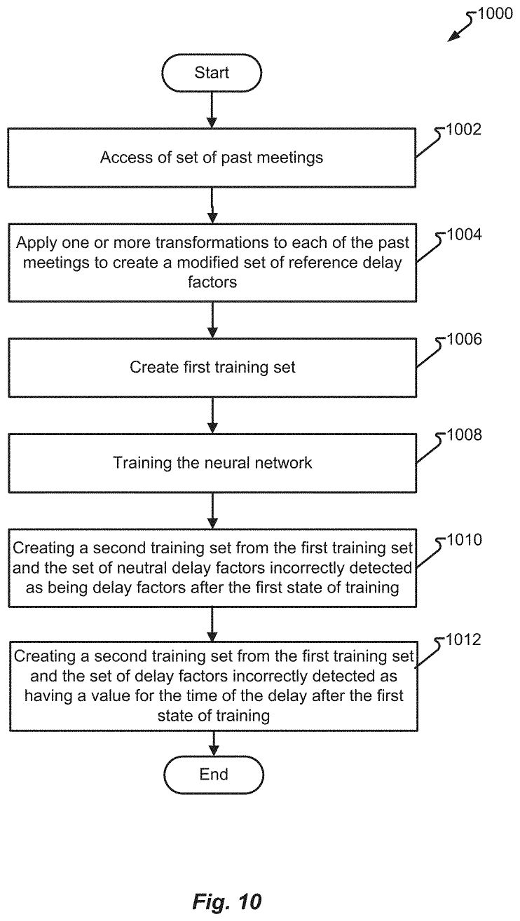

FIG. 10 depicts process 1000 in accordance with embodiments of the present disclosure. Process 1000 may be embodied as machine-readable instructions maintained in a non-transitory memory that, when read by a processor such as a processor of user device 104 or server 106, cause the processor to execute the steps of process 1000. In one embodiment, process 1000 trains a neural network and, after training, meeting information for an upcoming meeting is provided to the neural network to receive therefrom one or more delay factors.

A neural network, as is known in the art and in one embodiment, self-configures layers of logical nodes having an input and an output. If an output is below a self-determined threshold level, the output is omitted (i.e., the inputs are within the inactive response portion of a scale and provide no output), if the self-determined threshold level is above the threshold, an output is provided (i.e., the inputs are within the active response portion of a scale and provide an output), the particular placement of the active and inactive delineation is provided as a training step or steps. Multiple inputs into a node produce a multi-dimensional plane (e.g., hyperplane) to delineate a combination of inputs that are active or inactive.

Process 1000 begins and, in step 1002, a set of past meetings is accessed, such as from records maintained in data storage 110 for user 102 and/or other past meetings form other users. Meeting information comprises at least a scheduled start time and meeting attributes comprising one or more of location, application-indicating information, location-indicating information, network-indicating information, personal needs-indicating information, and priority-indicating information. Each of the attributes having an associated delay factor. The delay factor may be positive (e.g., additional time before the meeting is necessary to attend to the factor), negative (e.g., time is saved when the factor is present), or neutral (e.g., no affect on delay or the time of the advance notification).

Next, step 1004 applies one or more transformations to the attributes of the past meetings to create a modified set of reference delay factors. Transformations may comprise one or more of adding, deleting, or changing required software applications, network access, network type, location, personal needs, and/or priority, and as a further option neural events.

Step 1006 then creates a first training set and utilized to train the neural network in step 1008. The first training set then providing a baseline value for meetings and modifications to meetings to determine delay factors. As an example, a past meeting required a conferencing application and attachment to a wireless network. A modification may add a word processing application and, based on other meetings that required a word processing application, a delay factor determined for the modified meeting. However, the results may require improvement. Accordingly, in step 1010 a second training set is created from the first training set of neutral delay factors incorrectly detected as being delay factors in the first training set. For example, the first training set may incorrectly conclude that a meeting conducted in “conference room A” but modified to be “conference room B” had an impact on the delay. However, step 1010 retrains the neural network with the second training set to correct the error.

Additionally or alternatively to step 1010, step 1012 trains the neural network based on the time of a delay factor determined from the first training set. For example, the first training set may incorrectly conclude that a meeting conducted in “conference room A” but modified to be “conference room B” had a five-minute impact on the delay. However, step 1010 retrains the neural network with the second training set to correct the error, such as to indicate that no delay or a different amount of delay is associated with the modification.

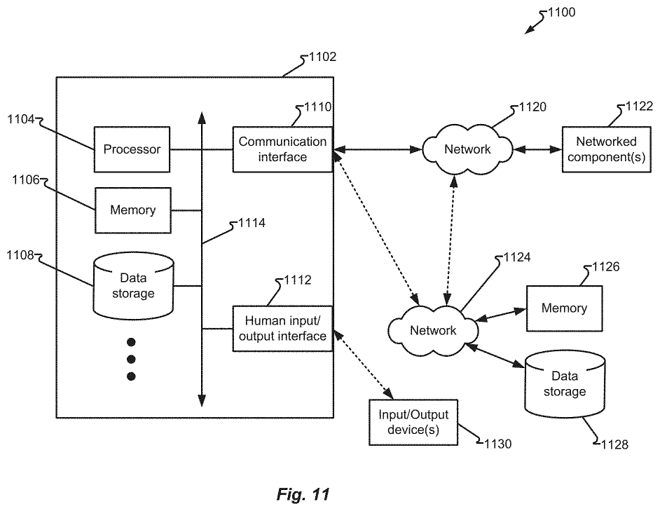

FIG. 11 depicts device 1102 in system 1100 in accordance with embodiments of the present disclosure. In one embodiment, user device 104 and/or server 106 may be embodied, in whole or in part, as device 1102 comprising various components and connections to other components and/or systems. The components are variously embodied and may comprise processor 1104. The term “processor,” as used herein, refers exclusively to electronic hardware components comprising electrical circuitry with connections (e.g., pin-outs) to convey encoded electrical signals to and from the electrical circuitry. Processor 1104 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 1114, executes instructions, and outputs data, again such as via bus 1114. In other embodiments, processor 1104 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 1104 is a non-transitory computing device (e.g., electronic machine comprising circuitry and connections to communicate with other components and devices). Processor 1104 may operate a virtual processor, such as to process machine instructions not native to the processor (e.g., translate the VAX operating system and VAX machine instruction code set into Intel® 9xx chipset code to allow VAX-specific applications to execute on a virtual VAX processor), however, as those of ordinary skill understand, such virtual processors are applications executed by hardware, more specifically, the underlying electrical circuitry and other hardware of the processor (e.g., processor 1104). Processor 1104 may be executed by virtual processors, such as when applications (i.e., Pod) are orchestrated by Kubernetes. Virtual processors allow an application to be presented with what appears to be a static and/or dedicated processor executing the instructions of the application, while underlying non-virtual processor(s) are executing the instructions and may be dynamic and/or split among a number of processors.

In addition to the components of processor 1104, device 1102 may utilize memory 1106 and/or data storage 1108 for the storage of accessible data, such as instructions, values, etc. Communication interface 1110 facilitates communication with components, such as processor 1104 via bus 1114 with components not accessible via bus 1114. Communication interface 1110 may be embodied as a network port, card, cable, or other configured hardware device. Additionally or alternatively, human input/output interface 1112 connects to one or more interface components to receive and/or present information (e.g., instructions, data, values, etc.) to and/or from a human and/or electronic device. Examples of input/output devices 1130 that may be connected to input/output interface include, but are not limited to, keyboard, mouse, trackball, printers, displays, sensor, switch, relay, speaker, microphone, still and/or video camera, etc. In another embodiment, communication interface 1110 may comprise, or be comprised by, human input/output interface 1112. Communication interface 1110 may be configured to communicate directly with a networked component or utilize one or more networks, such as network 1120 and/or network 1124.

Network 108 may be embodied, in whole or in part, as network 1120. Network 1120 may be a wired network (e.g., Ethernet), wireless (e.g., WiFi, Bluetooth, cellular, etc.) network, or combination thereof and enable device 1102 to communicate with networked component(s) 1122. In other embodiments, network 1120 may be embodied, in whole or in part, as a telephony network (e.g., public switched telephone network (PSTN), private branch exchange (PBX), cellular telephony network, etc.)

Additionally or alternatively, one or more other networks may be utilized. For example, network 1124 may represent a second network, which may facilitate communication with components utilized by device 1102. For example, network 1124 may be an internal network to a business entity or other organization, whereby components are trusted (or at least more so) that networked components 1122, which may be connected to network 1120 comprising a public network (e.g., Internet) that may not be as trusted.

Components attached to network 1124 may include memory 1126, data storage 1128, input/output device(s) 1130, and/or other components that may be accessible to processor 1104. For example, memory 1126 and/or data storage 1128 may supplement or supplant memory 1106 and/or data storage 1108 entirely or for a particular task or purpose. For example, memory 1126 and/or data storage 1128 may be an external data repository (e.g., server farm, array, “cloud,” etc.) and allow device 1102, and/or other devices, to access data thereon. Similarly, input/output device(s) 1130 may be accessed by processor 1104 via human input/output interface 1112 and/or via communication interface 1110 either directly, via network 1124, via network 1120 alone (not shown), or via networks 1124 and 1120. Each of memory 1106, data storage 1108, memory 1126, data storage 1128 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 1130 may be a router, switch, port, or other communication component such that a particular output of processor 1104 enables (or disables) input/output device 1130, which may be associated with network 1120 and/or network 1124, to allow (or disallow) communications between two or more nodes on network 1120 and/or network 1124. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARIV1926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
a network interface to a network;
a data storage; and
a processor having machine-readable instructions maintained in a non-transitory memory that when read by the processor cause the processor to perform:
access a meeting on a calendar of a user, the meeting maintained as a data record in the data storage;
access a desired start time of the meeting for the user;
determine a number of delay factors, corresponding to a number of attributes associated with the meeting that will be encountered by the user between a notification message being presented by a user device and the user joining the meeting;
determine an advance notification time for the meeting comprising the number of delay factors before the desired start time; and
cause the user device to present the notification at the advance notification time.

2. The system of claim 1, wherein the desired start time is the start time of the meeting.

3. The system of claim 1, wherein the instructions cause the processor to determine the number of delay factors comprising providing the meeting to a neural network trained to determine attributes from the meeting.

4. The system of claim 3, wherein the neural network is trained to determine the number of delay factors of the meeting, comprising:
accessing a set of past meetings maintained in the data storage;
applying one or more transformations to each past meeting in the set of past meetings including altering a time requirement associated with a delay factor of each past meeting to create a modified set of reference delay factors;
creating a first training set comprising the collected set of reference delay factors, the modified set of reference delay factors, and a set of non-delay meeting factors;
training the neural network in a first state using the first training set;
creating a second training set for a second state of training comprising the first training set and the set of non-delay meeting factors that are incorrectly detected as being delay factors after the first state of training; and
training the neural network in a second state using the second training set.

5. The system of claim 1, wherein the instructions cause the processor to determine the number of delay factors comprising determining one delay factor of the number of delay factors as a time required for the user to get from a current user location to a suitable meeting location.

6. The system of claim 5, wherein the suitable meeting location comprises a location accessible to the user to conduct the meeting that has an acceptable ambient sound level.

7. The system of claim 5, wherein the suitable meeting location comprises a location accessible to the user to conduct the meeting that has an acceptable network capacity.

8. The system of claim 1, wherein the instructions cause the processor to determine the number of delay factors comprising determine one delay factor of the number of delay factors as a personal time wherein the user is not engaged in any communication comprising the user device.

9. The system of claim 1, wherein the instructions cause the processor to determine the number of delay factors comprising determine one delay factor of the number of delay factors as a time to connect to a network utilized to communicate portions of the meeting to the user device.

10. The system of claim 1, wherein the instructions cause the processor to determine the number of delay factors comprising determine one delay factor of the number of delay factors as a time to launch an application of the user device designated as required for the meeting.

11. The system of claim 1, wherein the instructions further cause the processor to:
access a scheduled start time of the meeting;
upon determining the desired start time of the meeting for the user is after the scheduled start time, generating a delay message, the delay message comprising indicia of a delay comprising the desired start time of the meeting; and
sending the delay message to at least one of a host of the meeting or an attendee of the meeting.

12. A method, comprising:
accessing a meeting on a calendar of a user, the meeting maintained as a data record in a data storage;
accessing a desired start time of the meeting for the user;
determining a number of delay factors, corresponding to a number of attributes associated with the meeting that will be encountered by the user between a notification message being presented by a user device and the user joining the meeting;
determining an advance notification time for the meeting comprising the number of delay factors before the desired start time; and
causing the user device to present the advance notification at the notification time.

13. The method of claim 12, wherein the desired start time is different from the start time of the meeting.

14. The method of claim 12, wherein determining the number of delay factors further comprises providing the meeting to a neural network trained to determine attributes from the meeting.

15. The method of claim 14, wherein the neural network is trained to determine the number of delay factors of the meeting, comprising:
accessing a set of past meetings maintained in the data storage;
applying one or more transformations to each past meeting in the set of past meetings including altering a time requirement associated with a delay factor of each past meeting to create a modified set of reference delay factors;
creating a first training set comprising the collected set of reference delay factors, the modified set of reference delay factors, and a set of non-delay meeting factors;
training the neural network in a first state using the first training set;
creating a second training set for a second state of training comprising the first training set and the set of non-delay meeting factors that are incorrectly detected as being delay factors after the first state of training; and
training the neural network in a second state using the second training set.

16. The method of claim 12, wherein the instructions cause the processor to determine the number of delay factors comprising determining one delay factor of the number of delay factors as a time required for the user to get from a current user location to a suitable meeting location.

17. The method of claim 16, wherein the suitable meeting location comprises a location accessible to the user to conduct the meeting that has an acceptable ambient sound level.

18. The method of claim 16, wherein the suitable meeting location comprises a location accessible to the user to conduct the meeting that has an acceptable network capacity.

19. The method of claim 12, wherein determining the number of delay factors comprising determine one delay factor of the number of delay factors as a time to connect to a network utilized to communicate portions of the meeting to the user device.

20. The method of claim 12, wherein the instructions cause the processor to determine the number of delay factors comprising determine one delay factor of the number of delay factors as a time to launch an application of the user device designated as required for the meeting.

21. A system, comprising:
means to access a meeting on a calendar of a user, the meeting maintained as a data record in a data storage;
means to access a desired start time of the meeting for the user;
means to determine a number of delay factors, corresponding to a number of attributes associated with the meeting that will be encountered by the user between a notification message being presented by a user device and the user joining the meeting;
means to determine an advance notification time for the meeting comprising the number of delay factors before the desired start time; and
means to cause the user device to present the advance notification at the notification time.
